(19) United States
(12) Patent Application Publication
(10) Pub. No.: US 2001/0037437 A1
(43) Pub. Date: Nov. 1, 2001

(54) Information processing device

(76) Inventor: Yasuhiro Ishikawa, Kawasaki (JP)

Correspondence Address: Helfgott & Karas, P.C., 350 Fifth Avenue, Suite 6024, New York, NY, 10118, US

(21) Appl. No.: 09/860,143

(22) Filed: May 17, 2001

Related U.S. Application Data
(63) Continuation of application No. PCT/JP98/05267, filed on Nov. 20, 1998.

(51) Int. Cl. G06F 12/00

(52) U.S. Cl. 711/154; 711/104

(57) ABSTRACT

An information processing device which is simplified in hardware and software configuration. A central processing section controls individual parts of the device and executes predetermined processes in accordance with programs. A first semiconductor memory stores programs executed by the central processing section as well as data derived in the middle of processing. A bus interconnects the central processing section, the first semiconductor memory, and selective connection means. The selective connection means selects either a second or third semiconductor memory by making reference to a selection register, and connects the selected memory to the bus. In accordance with the settings of a transfer register, transfer means transfers data between the first semiconductor memory and the second or third semiconductor memory. The second semiconductor memory stores system firmware etc., while the third semiconductor memory stores data newly generated as a result of the processing by the central processing section, etc.

### BACKGROUND OF THE INVENTION

(1) Field of the Invention

The present invention relates to an information processing device, and more particularly, to an information processing device for executing predetermined processes in accordance with programs.

(2) Description of the Related Art

An information processing device such as a computer or the like has firmware, which includes basic programs for the system, data, etc., and software prepared to attain the purpose of processing, and the firmware and the software are loaded into RAM (Random Access Memory) etc. as needed and executed, whereby information can be processed in various ways.

To keep various data obtained as a result of is called a nonvolatile storage so that the stored contents may not be lost even after the power supply to the device is cut off. Also, for the same reason, the software needs to be stored in a nonvolatile storage.

In many cases, hard disk drive, optical disk drive, etc. are generally used as the nonvolatile storage, but the addition of such storage to the information processing device very often leads to complication of control of the storage.

FIG. 9 shows an exemplary configuration of a conventional information processing device to which a nonvolatile storage unit is added. In FIG. 9, a CPU (Central Processing Unit) 1 controls individual parts of the device and also performs predetermined processes in accordance with programs stored in a RAM 5 etc.

A system bus 2 electrically connects the CPU 1 to other devices (e.g., external devices) to permit exchange of information between these elements.

A system bus handler 3 manages access to the system bus 2 and also performs, for example, a bus congestion-related process etc.

A memory access controller 4 controls access to the RAM 5 as well as to a firmware flash EEPROM (Electrically Erasable Programmable Read Only Memory) 6.

When a certain program is executed by the CPU 1, the RAM 5 temporarily stores the program under execution as well as data derived in the middle of processing.

The firmware flash EEPROM 6 stores programs and data that are basic to system operation, for example, an IPL (Initial Program Loader) and a program and data for initializing peripheral devices etc.

A nonvolatile storage unit 7 comprises a control register 7a, a bus 7b, a CPU 7c, and an I/O file memory 7d.

The control register 7a has values set therein that are necessary to exchange data between the I/O file memory 7d and an external memory (e.g., RAM 5), as described later.

The CPU 7c controls the I/O file memory 7d in accordance with the settings of the control register 7a, to transfer the stored data to outside, or conversely, to transfer data to the I/O file memory 7d from outside.

The I/O file memory 7d is, for example, a hard disk drive or the like, and stores data supplied thereto through the control register 7a.

FIGS. 10(A) to 10(C) illustrate types of registers provided in the control register 7a. FIG. 10(A) shows a command address register which stores a start address, that is, a command address (CMA), of a channel control word (CCW) prepared by the CPU 1 on the RAM 5.

FIG. 10(B) shows an order type register which stores an order type, such as start I/O (SIO), maintenance channel (MCH), etc., that the CPU 1 issues with respect to the nonvolatile storage unit 7.

FIG. 10(C) shows an initial status register for holding a condition code (CDC), which is the result of checking as to whether or not the order issued from the CPU 1 is normal.

The order issued from the CPU 1 is checked by the nonvolatile storage unit 7 as to whether the order is an undefined order or not, and the result of checking is set as the condition code (CDC) in the initial status register (ISR).

FIG. 11 shows a termination status register which holds, as a termination status, the result of execution of the order issued from the CPU 1. In the termination status register, the result of order processing by the nonvolatile storage unit 7 is set as a 3-word channel status word (CSW) by the nonvolatile storage unit 7.

FIG. 12 illustrates a data structure of a channel control word written in the RAM 5 shown in FIG. 9. The channel control word is data prepared on the RAM 5 by the CPU 1 shown in FIG. 9, and provides field-by-field definition of the meaning of data stored in the RAM.

In the figure, “CMC” represents a command code, which is an instruction that the CPU 1 causes the nonvolatile storage unit 7 to execute.

“FLG” is a flag and is information specifying a mode of execution of the command code (CMC).

“LBC” represents a transfer block count and is information specifying the number of blocks of data to be transferred.

“DA” represents a transfer start address of the RAM 5 in cases where block transfer is to be performed.

“LBA” represents a transfer start block address of the I/O file memory 7d in cases where block transfer is to be performed.

Operation of the above conventional device will be now described. The following describes an example of operation wherein data is transferred between the RAM 5 and the nonvolatile storage unit 7.

(1) Activation Acceptance Process

The CPU 1 first writes a load start address (CMA) on the RAM 5 of a channel control word (CCW) in the command address register (see FIG. 10(A)), and then writes an order, such as SIO (start IO), MCH (maintenance channel) or the like, in the order type register (see FIG. 10(B)).

The nonvolatile storage unit 7 determines whether or not the written order is an undefined order, and generates a condition code (CDC), which is then set in the initial status register (FIG. 10(C)).

The CPU 1 reads in the contents of the initial status register, and if the order is not an undefined order, it writes a random bit pattern in the initial status register to clear the same.

(2) Command Fetch Process

On detecting the clearing of the initial status register, the nonvolatile storage unit 7 looks up the type of order set in the order type register as well as the load start address (CMA), to fetch the channel control word (CCW) stored in the RAM 5.

(3) Command Execution Process

The nonvolatile storage unit 7 analyzes the contents of a command stored in the channel control word (CCW), and performs a process instructed by the command, independently of the CPU 1.

(4) Termination Interrupt Process

The nonvolatile storage unit 7 terminates the process when transfer of the number of data blocks specified by the transfer block count (LBC) (see FIG. 12) of the channel control word (CCW) has been completed or when abnormality is detected during the transfer of data, then stores a status of the process termination in the termination status register (FIG. 11) as a channel status word (CSW), and generates an interrupt.

Consequently, the CPU 1 detects the termination of the transfer process and also can confirm whether the transfer has been completed normally or nor by looking up the channel status word in the termination status register.

The above four processes make it possible to transfer data between the RAM 5 and the nonvolatile storage unit 7.

The information processing device described above requires, in addition to the CPU 1 of the device side, the CPU 7c for controlling the nonvolatile storage unit 7, and thus is associated with a problem that the hardware configuration is complicated.

Also, in cases where data is transferred between the RAM 5 and the nonvolatile storage unit 7, the data transfer is performed by what is called a “channel control method” described above. The method, however, involves an extremely complicated procedure for performing the data transfer process, such as the exchange of order through the RAM 5.

As a result, the transfer process requires considerable time and also the software for controlling the transfer process becomes complicated.

Further, in cases where the I/O file memory 7d is a hard disk drive or an optical disk drive, such a drive includes mechanically operating parts; therefore, the reliability is low and it is difficult to reduce the overall size of the device.

The I/O file memory 7d may alternatively be constituted by a semiconductor memory such as flash EEPROM etc. Even in this case, it is difficult to solve the first-mentioned two problems.

### SUMMARY OF THE INVENTION

The present invention was created in view of the above circumstances, and an object thereof is to provide an information processing device which is high in reliability and can be easily reduced in size because of the combination of simple hardware configuration and simple software.

To achieve the above object, the present invention provides an information processing device for executing a predetermined process in accordance with a program. The information processing device comprises a central processing section for executing a predetermined process in compliance with a command described in the program, a rewritable first semiconductor memory for temporarily storing a program to be executed when a predetermined process is to be executed by the central processing section, a bus electrically connecting the central processing section and the first semiconductor memory to permit exchange of data therebetween, a second semiconductor memory storing firmware, a nonvolatile third semiconductor memory permitting rewriting of stored contents thereof, and selective connection means for electrically connecting one of the second semiconductor memory and the third semiconductor memory to the bus.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principle of operation according to the present invention;

FIG. 2 is a block diagram showing an exemplary configuration according to an embodiment of the present invention;

FIG. 3 is a diagram showing an example of data structure of a first file memory control register (FCR1) provided in a control register appearing in FIG. 2;

FIG. 4 is a diagram showing an example of data structure of a second file memory control register (FCR2) provided in the control register appearing in FIG. 2;

FIG. 5 is a diagram showing an example of data structure of a third file memory control register (FCR3) provided in the control register appearing in FIG. 2;

FIG. 6 is a diagram showing an example of data structure of a fourth file memory control register (FCR4) provided in the control register appearing in FIG. 2;

FIG. 7 is a flowchart illustrating an exemplary process executed when data is downloaded in the embodiment shown in FIG. 2;

FIG. 8 is a flowchart illustrating an exemplary process executed when data is uploaded in the embodiment shown in FIG. 2;

FIG. 9 is a diagram showing an exemplary configuration of a conventional information processing device;

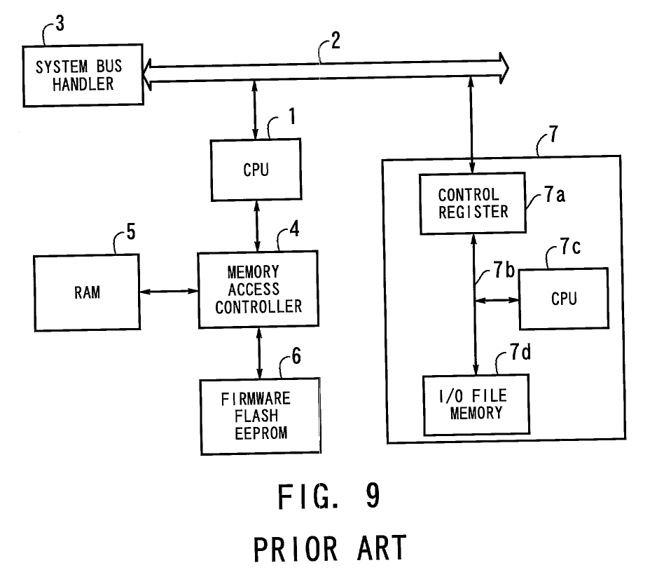

FIGS. 10(A) to 10(C) show examples of registers provided in a control register appearing in FIG. 9, wherein FIG. 10(A) shows a data structure of a command address register, FIG. 10(B) shows a data structure of an order type register, and FIG. 10(C) shows a data structure of an initial status register;

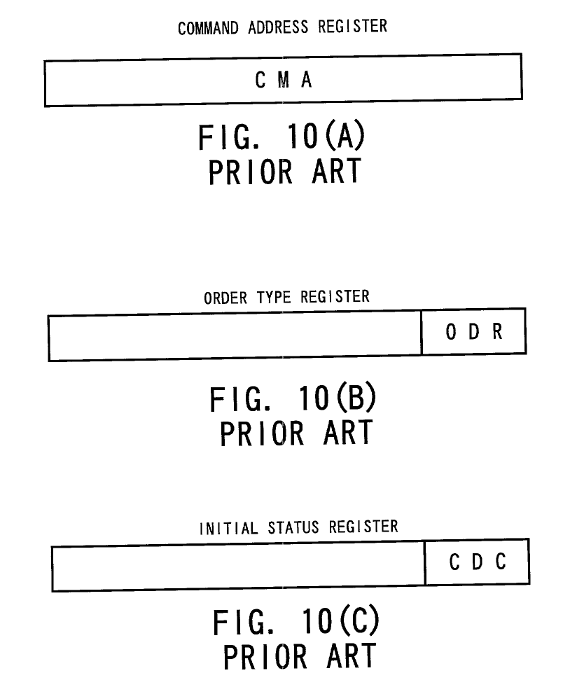

FIG. 11 is a diagram showing an example of data structure of a termination status register provided in the control register appearing in FIG. 9; and

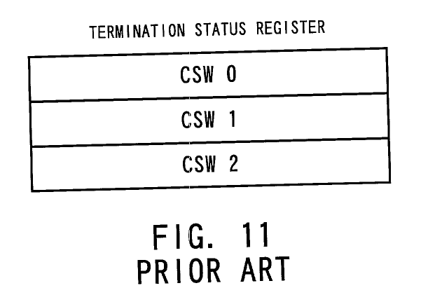

FIG. 12 is a diagram showing an example of data structure of a channel control word written in a RAM appearing in FIG. 9.

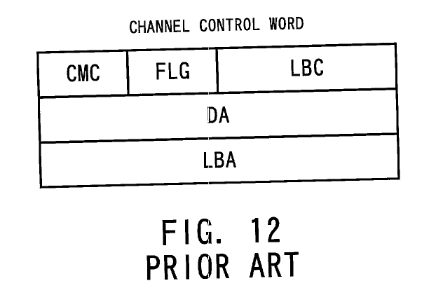

### DESCRIPTION OF THE PREFERRED EMBODIMENTS

An embodiment of the present invention will be hereinafter described with reference to the drawings.

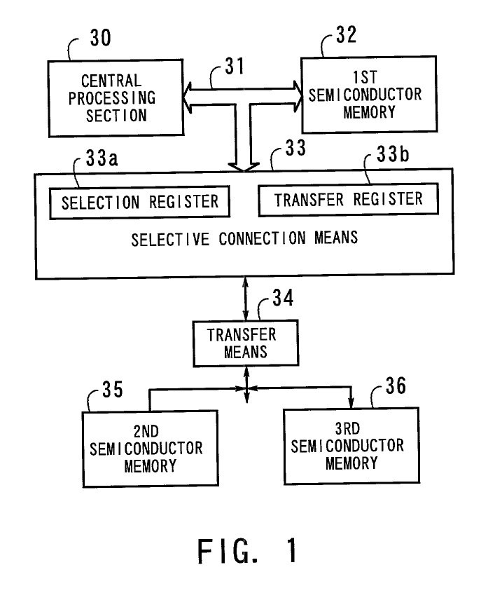

FIG. 1 illustrates the principle of operation according to the present invention. In FIG. 1, a central processing section 30, which comprises a CPU or the like, for example, controls individual parts of the illustrated device and also executes predetermined processes in accordance with programs stored in a first semiconductor memory 32 etc.

The first semiconductor memory 32 comprises a DRAM (Dynamic RAM), for example, and stores programs executed by the central processing section 30 as well as data derived in the middle of processing.

A bus 31 electrically connects the central processing section 30, the first semiconductor memory 32 and selective connection means 33, described below, to one another and permits exchange of data between these elements.

The selective connection means 33 selects one of second and third semiconductor memories 35 and 36, described later, and connects the selected one to the bus 31.

Transfer means 34 transfers data between the first semiconductor memory 32 and the second or third semiconductor memory 35 or 36.

The second semiconductor memory 35 comprises a flash EEPROM or the like and stores firmware including basic programs for the system, data, etc.

The third semiconductor memory 36, which also comprises a flash EEPROM or the like, stores data newly generated as a result of the processing by the central processing section 30, newly input programs, etc.

The selective connection means 33 includes a selection register 33a, in which is set data necessary for selecting one of the second and third semiconductor memories 35 and 36.

A transfer register 33b is loaded with data, for example, a transfer start address, a transfer block count, etc., in cases where data is transferred between the first semiconductor memory 32 and the second or third semiconductor memory 35 or 36.

Operation in accordance with the illustrated principle will be now described.

First, the operation of transferring data from the first semiconductor memory 32 to the third semiconductor memory 36 will be explained.

The central processing section 30 sets predetermined data in the transfer register 33b and causes the stored contents to be erased from a region of the third semiconductor memory 36 where data is to be transferred.

After the erasure, the central processing section 30 sets an access start block address and access end address of the third semiconductor memory 36 in the transfer register 33b of the selective connection means 33.

Also, the central processing section 30 sets information indicative of the selection of the third semiconductor memory 36 in the selection register 33a of the selective connection means 33.

Subsequently, the central processing section 30 acquires first data from the first semiconductor memory 32 and writes the acquired data in a predetermined field of the transfer register of the selective connection means 33.

Consequently, the transfer means 34 acquires the written data from the transfer register 33b of the selective connection means 33, and transfers the acquired data to a predetermined region of the third semiconductor memory 36 to be written therein.

As a result, the data read out from the first semiconductor memory 32 is written in the predetermined region of the third semiconductor memory 36. A similar operation is repeated, whereby data can be transferred from the first semiconductor memory 32 to the third semiconductor memory 36.

The operation of transferring data from the third semiconductor memory 36 to the first semiconductor memory 32 will be now explained.

The central processing section 30 sets a transfer block start address of the first semiconductor memory 32 and an access start block address and access end address of the third semiconductor memory 36 in the transfer register 33b of the selective connection means 33.

Then, the central processing section 30 sets information indicative of the selection of the third semiconductor memory 36 in the selection register 33a of the selective connection means 33.

Subsequently, the central processing section 30 writes data instructing the start of transfer in a predetermined field of the transfer register 33b of the selective connection means 33.

Consequently, the transfer means 34 reads out data from the predetermined region of the third semiconductor memory 36 and writes the data in the predetermined region of the first semiconductor memory 32 through the selective connection means 33. Such operation is repeatedly executed until the transfer of all data in the region specified by the access start block address and access end address stored in the transfer register 33b is completed.

As a result, data transfer (block transfer) from the third semiconductor memory 36 to the first semiconductor memory 32 is completed.

A process for transferring data from the second semiconductor memory 35 to the first semiconductor memory 32 is identical with the process for transferring data from the third semiconductor memory 36 to the first semiconductor memory 32, and therefore, description thereof is omitted.

As explained above, according to the present invention, predetermined values have only to be set in the selection register 33a and the transfer register 33b by the central processing section 30 in order to carry out data transfer between the first semiconductor memory 32 and the second or third semiconductor memory 35 or 36. Thus, only a simple procedure needs to be followed to transfer data.

Also, the second semiconductor memory 35 storing firmware and the third semiconductor memory 36 storing programs, data, etc. are controlled by a common functional block (selective connection means 33 and transfer means 34), whereby the hardware configuration can be simplified.

Further, according to the present invention, in cases where data is transferred from the second or third semiconductor memory 35 or 36 to the first semiconductor memory 32, the data transfer is carried out by means of block transfer that permits collective transfer of multiple data blocks. Thus, the data transfer in the direction of most frequent occurrence is speeded up, making it possible to increase the processing speed of the device.

An embodiment of the present invention will be now described.

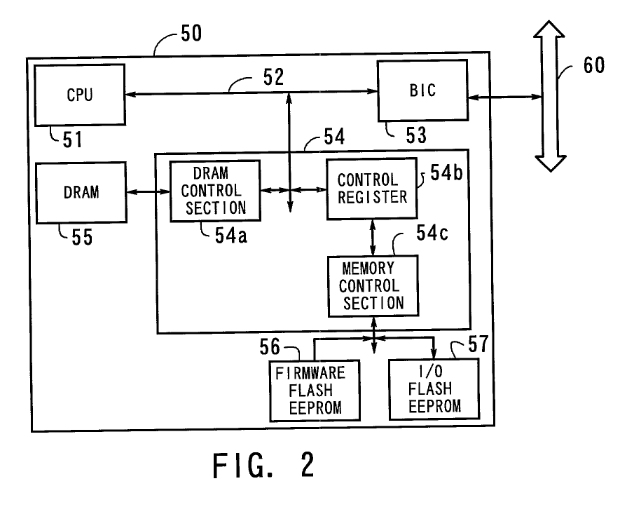

FIG. 2 is a block diagram showing an exemplary configuration according to the embodiment of the invention.

In this embodiment, the present invention is embodied in a CC (Central Controller) 50. In FIG. 2, the CC 50 is connected to a system bus 60 and exchanges information with other devices (not shown) connected to the system bus 60 to perform required processes.

The CC 50 comprises a CPU 51, a processor bus 52, a BIC (Bus Interface Controller) 53, a memory access controller 54, a DRAM 55, a firmware flash EEPROM 56, and an I/O flash EEPROM 57.

The CPU 51 controls the individual parts of the device and also executes various operations in accordance with programs stored in the DRAM 55 etc.

The processor bus 52 electrically connects the CPU 51, the BIC 53 and the memory access controller 54 to one another, to permit exchange of information between these elements.

When operations are performed by the CPU 51, the DRAM 55 temporarily stores programs to be executed, data derived in the middle of operations, etc.

The memory access controller 54 suitably selects one of the firmware flash EEPROM 56 and the I/O flash EEPROM 57 to read out the stored contents thereof. Also, the controller 54 writes information in the I/O flash EEPROM 57.

The memory access controller 54 comprises a DRAM control section 54a, a control register 54b, and a memory control section 54c.

The DRAM control section 54a writes data in the DRAM 55 at an address specified by the CPU 51, and also reads out data from an address of the DRAM 55 specified by the CPU 51.

In the control register 54b is set data necessary for reading/writing data from/into the firmware flash EEPROM 56 or the I/O flash EEPROM 57.

The memory control section 54c controls the firmware flash EEPROM 56 or the I/O flash EEPROM 57 in accordance with the settings of the control register 54b.

The firmware flash EEPROM 56 stores what is called firmware which includes, for example, an IPL, information on the settings of peripheral devices, etc. At the time of firmware update, the contents of the EEPROM 56 can be rewritten (firmware can be downloaded), like I/O file memory.

The I/O flash EEPROM 57 stores various application programs, data newly generated as a result of the processing by the CPU 51, etc., and information stored therein is read out and supplied as needed.

The control register 54b will be now described in detail.

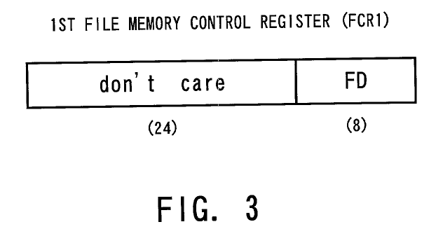

FIG. 3 shows an example of data structure of a first file memory control register (hereinafter abbreviated as FCR1) provided in the control register 54b.

In the FCR1 is stored various data necessary for transferring (hereinafter “downloading”) data stored in the DRAM 55 to the I/O flash EEPROM 57. In the illustrated example, the LSB (Least Significant Bit) through to the seventh bit constitute an FD field for storing data to be transferred, and the other field (eighth bit through to the MSB (Most Significant Bit)) than the FD field is made invalid (don't care).

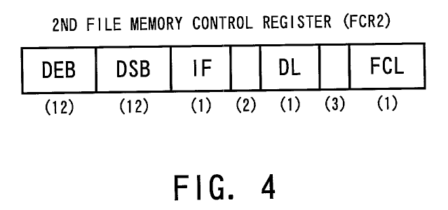

FIG. 4 shows an example of data structure of a second file memory control register (hereinafter abbreviated as FCR2) provided in the control register 54b.

The FCR2 stores a transfer address of the firmware flash EEPROM 56 or the I/O flash EEPROM 57, information indicating which of the two EEPROMs is to be selected, etc. when data is downloaded to the I/O flash EEPROM 57 or when data is transferred (hereinafter “uploaded”) from the firmware flash EEPROM 56 or the I/O flash EEPROM 57 to the DRAM 55.

Specifically, the LSB of the FCR2 constitutes an FCL field instructing erasure of the contents of the I/O flash EEPROM 57 and also indicating that the erasure is under way. The three bits to the left of the FCL field are made invalid, and the one bit next to the three invalid bits constitutes a DL field indicating that download is under way. The two bits to the left of the DL field are made invalid, and the one bit next to the two invalid bits constitutes an IF field for storing bit data indicating which of the firmware flash EEPROM 56 and the I/O flash EEPROM 57 is to be selected as a target of access. The next 12 bits constitute a DSB field for storing data indicating an access end block address of the firmware flash EEPROM 56 or the I/O flash EEPROM 57 where data is transferred. The leftmost 12 bits constitute a DEB field for storing data indicating an access start block address of the firmware flash EEPROM 56 or the I/O flash EEPROM 57 where data is transferred.

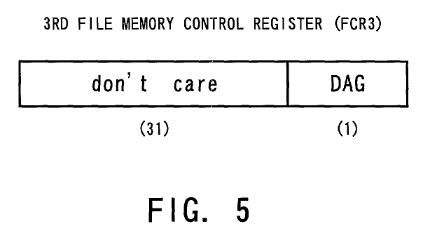

FIG. 5 shows an example of data structure of a third file memory control register (hereinafter abbreviated as FCR3) provided in the control register 54b.

The FCR3 stores information indicative of authorization to update the I/O flash EEPROM 57. Specifically, the LSB of the FCR3 constitutes a DAG field for storing information indicative of authorization to update the I/O flash EEPROM 57. The other field than the DAG field is made invalid.

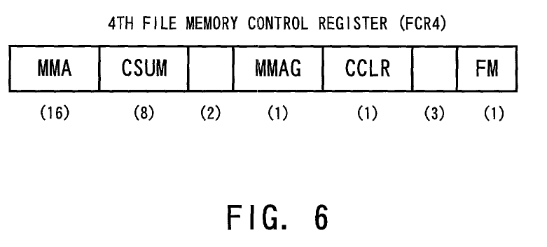

FIG. 6 shows an example of data structure of a fourth file memory control register (hereinafter abbreviated as FCR4) provided in the control register 54b.

The FCR4 stores data necessary for downloading data to the DRAM 55.

Specifically, the LSB of the FCR4 constitutes an FM field for storing data indicating that download is under way, and the next three bits are made invalid. The one bit to the left of the three invalid bits constitutes a CCLR field for storing data instructing clearing of a checksum, described below. The next one bit constitutes an MMAG field for holding write guard information for an MMA field, described below. The two bits to the left of the MMAG field are made invalid. The eight bits next to the two invalid bits constitute a CSUM field for storing a checksum in cases where data is read from or write into the firmware flash EEPROM 56 or the I/O flash EEPROM 57. The leftmost 16 bits constitute the MMA field for storing a transfer block start address of the DRAM 55 at the time of downloading.

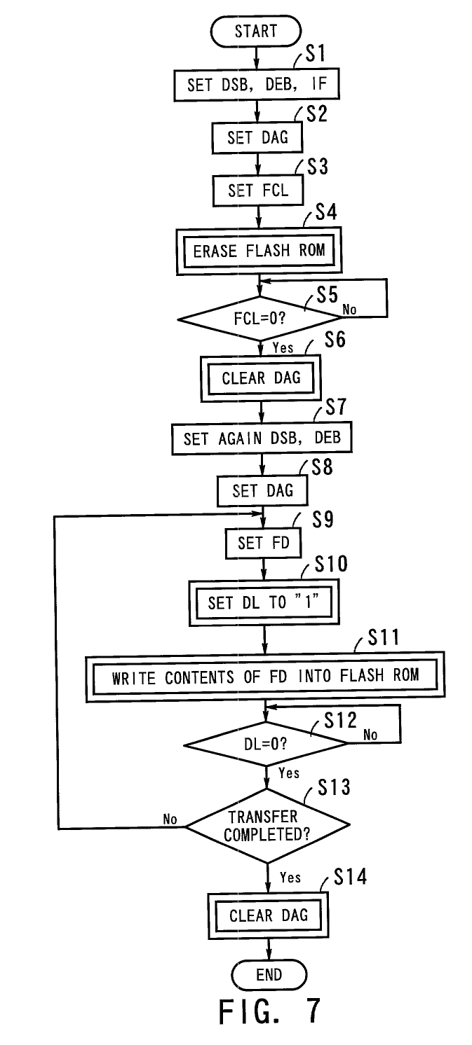

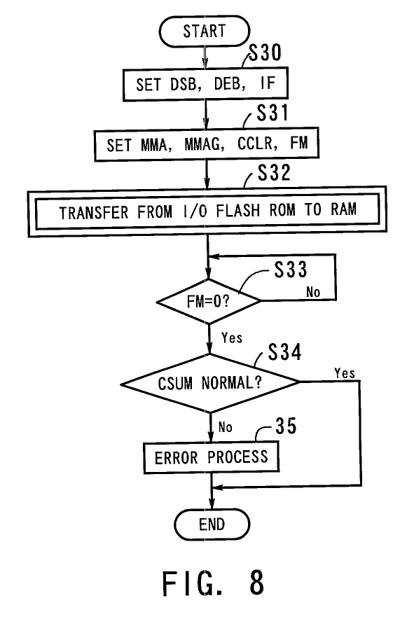

Referring now to FIGS. 7 and 8, the operation of the above embodiment will be described.

FIG. 7 is a flowchart illustrating an exemplary process executed when data stored in the DRAM 55 is downloaded to the I/O flash EEPROM 57. Upon start of the process shown in the flowchart, the steps described below are executed. In FIG. 7, the steps enclosed by a double line are executed mainly by the memory control section 54c, while the other steps are executed by the CPU 51.

[S1] The CPU 51 sets predetermined data in the DSB, DEB and IF fields of the FCR2 shown in FIG. 4.

Specifically, the access start block address and access end block address of the I/O flash EEPROM 57 are set in the DSB and DEB fields, respectively. Also, since the destination of transfer is the I/O flash EEPROM 57, bit data “1” indicative of the selection of the I/O flash EEPROM 57 is set in the IF field.

[S2] The CPU 51 sets bit data “1”, which indicates a request for authorization to update the I/O flash EEPROM 57, in the DAG field of the FCR3 shown in FIG. 5.

[S3] The CPU 51 sets bit data “1”, which indicates a request for start of erasure of the contents of the I/O flash EEPROM 57, in the FCL field of the FCR2 shown in FIG. 4.

[S4] The memory control section 54c detects writing of the bit data “1” in the FCL field, and since the bit data “1” is also written in the IF field, it recognizes that erasure of the contents stored in the I/O flash EEPROM 57 has been instructed. Consequently, the memory control section 54c looks up the addresses stored in the DEB and DSB fields, and starts a process for erasing the contents of the I/O flash EEPROM 57 stored in the range specified by the addresses. Upon completion of the erasure, the memory control section 54c sets bit data “0” in the FCL field of the control register 54b, thereby indicating that the erasure has been completed.

[S5] The CPU 51 looks up the FCL field shown in FIG. 4 to determine whether or not the erasure has been completed. If the erasure has been completed, the flow proceeds to Step S6; if not, Step S5 is repeatedly executed.

[S6] The memory control section 54c sets bit data in the DAG field shown in FIG. 5, to indicate that update of the I/O flash EEPROM 57 is not authorized.

[S7] The CPU 51 sets again DSB and DEB, if necessary.

In cases where the range of the data erasure from the I/O flash EEPROM 57 is identical with a downloading range, DSB and DEB need not be set again.

[S8] The CPU 51 sets bit data “1” indicating a request for authorization to update the I/O flash EEPROM 57 in the DAG field of the FCR3 shown in FIG. 5.

[S9] The CPU 51 provides the DRAM control section 54a with an address of data to be downloaded, and sets data supplied as a result from the DRAM control section 54a in the FD field of the FCR1 shown in FIG. 3.

[S10] The memory control section 54c detects writing of the data in the FD field of the FCR1, and thus sets bit data “1” in the DL field of the FCR2 shown in FIG. 4, to indicate that download is under way.

[S11] The memory control section 54c acquires the data written in the FD field, then looks up the DSB of the FCR2 shown in FIG. 4, and writes the data in the predetermined region of the I/O flash EEPROM 57. On completion of the write operation, the memory control section 54c sets bit data “0” in the DL field of the FCR2 shown in FIG. 4.

[S12] The CPU 51 looks up the DL field of the FCR2 shown in FIG. 4 to determine whether or not the download has been completed. If the download has been completed, the flow proceeds to Step S13; if not, Step S12 is repeatedly executed.

[S13] The CPU 51 determines whether or not the transfer of all data has been completed. If all data has been transferred, the flow proceeds to Step S14; if not, the flow returns to Step S9 and the same process is repeated.

[S14] The memory control section 54c sets bit data “0” in the DAG field shown in FIG. 5, and the process is ended (END).

The above process makes it possible to transfer (write) data stored in the DRAM 55 into the I/O flash EEPROM 57.

The process executed in this case by the CPU 51 includes only the setting of various registers and an actual data transfer process, whereby the process can be made simple compared with the channel control method.

The operation of uploading data from the firmware flash EEPROM 56 or the I/O flash EEPROM 57 to the DRAM 55 will be now described.

FIG. 8 is a flowchart illustrating an exemplary process executed when data is uploaded from the firmware flash EEPROM 56 or the I/O flash EEPROM 57 to the DRAM 55. Upon start of the process shown in the flowchart, the steps described below are executed. Also in FIG. 8, the step enclosed by a double line is executed mainly by the memory control section 54c.

[S30] The CPU 51 sets predetermined data in the DSB, DEB and IF fields of the FCR2 shown in FIG. 4.

Specifically, the CPU 51 sets the access start block address and access end block address of the firmware flash EEPROM 56 or the I/O flash EEPROM 57 in the DSB and DEB fields, respectively.

Also, in the IF field is set bit data “0” if the source of transfer is the firmware flash EEPROM 56, or bit data “1” if the source of transfer is the I/O flash EEPROM 57.

[S31] The CPU 51 sets predetermined data in the MMA, MMAG, CCLR and FM fields of the FCR4 shown in FIG. 6.

Specifically, the CPU 51 sets the transfer block start address of the DRAM 55 in the MMA field, and sets the bit “1” indicative of write guard for the MMA field in the MMAG field. Also, the CPU 51 sets bit data “1” in the CCLR field to request clearing of the CSUM field where a checksum is to be stored, and sets bit data “1” in the FM field to request the start of data transfer.

[S32] The memory control section 54c looks up the address information set in the DSB, DEB and MMA fields, and transfers data by block transfer from the firmware flash EEPROM 56 or the I/O flash EEPROM 57 to the DRAM 55.

Upon completion of the data transfer, the memory control section 54c sets bit data “0” in the FM field of the FCR4 of the control register 54b, to indicate that the transfer has been completed.

[S33] The CPU 51 determines whether or not the bit data stored in the FM field of the FCR4 shown in FIG. 6 has turned to “0”. If the bit data has turned to “0”, the flow proceeds to Step S34; if not, Step S33 is repeatedly

[S34] The CPU 51 looks up the CSUM field of the FCR4 shown in FIG. 6, to determine whether or not the data transfer has been normally executed. If the data transfer has been normally executed, the process is ended; if not, the flow proceeds to Step S35.

[S35] The CPU 51 displays a message indicating the occurrence of transfer error on a display device or the like, not shown, whereupon the process is ended (END).

According to the above process, by setting bit data in the IF field of the FCR2 to select the source of transfer and also suitably setting the other required registers, it is possible to transfer data by block transfer from either the firmware flash EEPROM 56 or the I/O flash EEPROM 57 to the DRAM 55.

As described above, according to this embodiment, the firmware flash EEPROM 56 and the I/O flash EEPROM 57 are controlled by the identical memory access controller 54, and accordingly, the hardware configuration can be simplified, thus making it possible to further reduce the scale of the circuitry of the information processing device etc.

Also, in this embodiment, the CPU 51 writes data directly into the control register 54b when performing a data transfer process, whereby the transfer process can be made simple, compared with the conventional channel control method etc. As a result, the size of software related to the data transfer can be cut down.

In the foregoing embodiment, a flash EEPROM is used as the I/O flash EEPROM 57. However, the memory to be used in the present invention is not limited to flash EEPROM alone, and any desired memory may be used insofar as it is nonvolatile and permits data rewrite.

As described above, according to the present invention, an information processing device for executing a predetermined process in accordance with a program comprises a central processing section for executing a predetermined process in compliance with a command described in the program, a rewritable first semiconductor memory for temporarily storing a program to be executed when a predetermined process is to be executed by the central processing section, a bus electrically connecting the central processing section and the first semiconductor memory to permit exchange of data therebetween, a second semiconductor memory storing firmware, a nonvolatile third semiconductor memory permitting rewriting of stored contents thereof, and selective connection means for electrically connecting one of the second semiconductor memory and the third semiconductor memory to the bus. Accordingly, by and the transfer register 33b, it is possible to transfer data between the first semiconductor memory and the second or third semiconductor memory, whereby both the hardware and the software can be simplified.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An information processing device for executing a predetermined process in accordance with a program, comprising:
a central processing section for executing a predetermined process in compliance with a command described in the program;
a rewritable first semiconductor memory for temporarily storing a program to be executed when a predetermined process is to be executed by said central processing section;
a bus electrically connecting said central processing section and said first semiconductor memory to permit exchange of data therebetween;
a second semiconductor memory storing firmware;
a nonvolatile third semiconductor memory permitting rewriting of stored contents thereof; and
selective connection means for electrically connecting one of said second semiconductor memory and said third semiconductor memory to said bus.

2. The information processing device according to claim 1, wherein said selective connection means includes a selection register for selecting one of said second and third semiconductor memories, and selects one of said second and third semiconductor memories in accordance with contents of the selection register set by said central processing section.

3. The information processing device according to claim 1, further comprising transfer means for transferring, by block transfer, data stored in said second or third semiconductor memory to said first semiconductor memory.

4. The information processing device according to claim 3, wherein said transfer means includes a transfer setting register for setting therein a start address of said first semiconductor memory as a destination of transfer, a start address of said second or third semiconductor memory as a source of transfer and a data size or end address of data to be transferred, and transfers the data in accordance with contents of settings by said central processing section.

5. The information processing device according to claim 1, wherein said second and third semiconductor memories each comprise a flash EEPROM.
